(19) United States
(12) Patent Application Publication
(10) Pub. No.: US 2014/0244803 A1
(43) Pub. Date: Aug. 28, 2014

(54) INTEGRATED APP STORE APPARATUS, A METHOD OF PROVIDING AN APPLICATION IN THE APPARATUS, AND AN INTEGRATED APP STORE SYSTEM

(71) Applicant: Electronics and Telecommunications Research Institute, Daejeon (KR)

(72) Inventors: Tae-Gun KANG, Daejeon (KR); Sang Yun LEE, Daejeon (KR); Seung Chul KIM, Daejeon (KR); In Cheol JEONG, Daejeon (KR); Seung-Hee KIM, Daejeon (KR); Sang Taick PARK, Seoul (KR); Jin Woo HONG, Daejeon (KR)

(73) Assignee: Electronics and Telecommunications Research Institute, Daejeon (KR)

(21) Appl. No.: 13/960,732

(22) Filed: Aug. 6, 2013

(30) Foreign Application Priority Data
Feb. 25, 2013 (KR) 10-2013-0019900

(51) Int. Cl. H04L 29/08

(52) U.S. Cl. CPC H04L 67/02
USPC 709/219

(57) ABSTRACT

An integrated app store device according to the present invention includes an authentication server performing registration and authentication on a client terminal, a content managing server performing one of registration, search, and download of an application, a web application server providing a web front for a user, and an interworking server providing an open API (Application Programming Interface) for an external app store to access. Accordingly, functions of an app store are defined in the form of a standard-based common interface (Open API) and various terminals and platform environments are supported, thus providing an open-type app store model that may be efficiently expanded even when the type of user terminal and type of service or business environment are varied.

### CROSS-REFERENCE TO RELATED APPLICATION

This application claims priority to Korean Patent Application No. 10-2013-0019900 filed on Feb. 25, 2013, the contents of which are herein incorporated by reference in its entirety.

### TECHNICAL FIELD

The present invention relates to an application store system and a method of providing an application, and more specifically, to an application store system that facilitates distribution of applications operating on a mobile terminal (smart phone) or its similar set-top device (smart TV and set-top box) having an operation software platform mounted therein and a method of providing an application.

### DISCUSSION OF THE RELATED ART

App stores currently operated in the nation may be typically classified into mobile app stores, combined app stores of mobile app stores (e.g., K-Apps), and smart TV app stores. Among them, the mobile app stores distributing mobile applications are each founded and run by each mobile communication service provider. A user may enroll in a mobile service provided by a mobile communication service provider using his mobile terminal and may access an app store operated by the mobile communication service provider. Smart TV app stores are also operated in a similar way to that of the mobile app stores. Each smart TV manufacturer runs its own app store, and a user may receive applications for his purchased smart TV by accessing the manufacturer's app store.

Meanwhile, in case mobile terminals from different manufacturers have the same operation software platform mounted therein, the mobile terminals may execute the same application without correction. In other words, smart phones having the same version of Android operation system may execute the same application regardless of their manufacturers unless they use hardware devices specific to the terminals provided by the manufacturers. However, each mobile communication service provider has been so far developing or supporting mobile applications using functions specific to its mobile terminals, and such applications have been taking up a dominant portion of each mobile app store. Little effort has been made to develop terminal-independent applications and to establish mobile app stores for the terminal-independent applications.

The KCC (Korea Communications Commission) has opened a Korean integrated app store (“K-Apps”) for distributing mobile applications following WAC (Wholesale Application Community) 2.0 standards which are international standards for mobile software in order to promote development of terminal-independent mobile software. The KCC has also defined domestic standards for WAC 2.0 widget-based terminal-independent mobile software so that mobile applications developed based on the standards may execute widgets irrespective of whatever terminal operation software platform has been adopted in case they have a widget runtime mounted therein.

Meanwhile, in the case of smart TV app stores, each smart TV maker has its own software platform that is different from those of other TV makers. Accordingly, smart TV applications are developed using the development tool (SDK) provided from each manufacturer and thus smart TV applications designed by different TV makers are not compatible with each other. For example, Samsung embeds its own operation system in its smart TVs and uses a flash-based software development framework thereon. LG smart TVs also have LG's own operation system loaded therein, and all applications are operated on Netcast 2.0 framework. As such, use of different operation systems and development framework renders it difficult for developers to execute one application on different smart TVs and is an obstacle to smart TVs spreading.

As an effort to develop applications that are device-independent and are not dependent on the operation platform, HTML5 standards have been introduced and currently have been almost done with standardization. Web applications supportive of HTML5 standards may be surely executed on mobile terminals that adopt different operation software platforms and different hardware devices only when the terminals have an HTML5 browser installed therein. Accordingly, in case mobile terminal makers or smart TV manufacturers install a browser satisfying HTML5 standards in their terminals and developers design applications using only the HTML5 supportive functions without using functions specific to the mobile terminal hardware, the applications may be provided to users through every app store. Existing browsers for desk top computers such as Internet explorer, chrome, safari, or fire fox, are now mostly supporting the HTML5 standards, and mobile applications—if satisfying the HTML5 standards—may be operated on desktop computer as well as on mobile terminals. Accordingly, the mobile application environment is now being prompted to develop web applications supporting HTML5.

In other words, as described above, app stores for smart TVs, each of which is being operated by each domestic TV manufacturer target applications for each maker's smart TVs only without considering compatibility with other makers' products. Mobile app stores that each used to be run by each of three mobile communication service provider have been integrated into K-Apps back on December, 2011 and are currently in service, but K-Apps is not very active. No integrated app stores currently service platform-independent HTML5 web applications that may support both smart TVs and mobile terminals, and there is thus considerable inconvenience in searching, downloading, installing and executing applications.

Accordingly, there is a need for a method of being able to provide a service that allows for search, download, and install of web applications developed to be capable of operating on mobile terminals as well as on smart TVs through interworking with an app store on another smart TV app store targeting HTML5 web applications that are device-independent and are not dependent on operation software platform.

### SUMMARY

To solve the above-described problems, an object of the present invention is to provide an integrated app store device that provides a service for a user to be able to search, download, install and execute applications on mobile app stores as well as applications on smart TV app stores by defining each app store function in an app store system for smart TV applications and an app store for mobile applications in a web service-type open API (Application Programming Interface) and by allowing software modules for servicing the API to operate in the app store, a method of providing an application in the device, and an integrated app store system.

Another object of the present invention is to provide an integrated app store device that manages applications so that the applications may be distributed through a single app store irrespective of the type and platform of the applications, a method of providing an application in the device, and an integrated app store system.

To achieve the above objects, an integrated app store device according to the present invention may include an authentication server performing registration and authentication on a client terminal, a content managing server performing one of registration, search, and download of an application, a web application server providing a web front for a user, and an interworking server providing an open API (Application Programming Interface) for an external app store to access.

The client terminal may be a smart TV or a set-top box, and the external app store may be a mobile app store.

The open API may be a common interface based on a WAC (Wholesale Application Community) or HTML5 standard and may support a plurality of different types of terminals and platform environments.

The integrated app store device may interwork with an app/terminal information database storing the application and terminal information and a data warehouse including an app package file storage storing an app execution package.

The content managing server may include a receiving unit receiving a request for registration of the application and the terminal from the client terminal, a registration requesting unit requesting registration of the application information and the terminal information in the app/terminal information database, and an app package file transmitting unit transmitting the app package file to the app package file storage.

The integrated app store device may further include a download server downloading the application to the client terminal, in which the content managing server syncs the web application server, the interworking server, and the download server with the application information.

The authentication server may include a client terminal communication unit receiving an authentication request of the client terminal and performing authentication of the client terminal in response to the authentication request and an app/terminal information database communication unit sending a request for and receiving terminal authentication information to/from the app/terminal information database.

The authentication server may transfer an app store URL (Universal Resource Locator) to the client terminal.

The web application server may include a receiving unit receiving an app store access request and an application information request from the client terminal and a transmitting unit transmitting application display information and an application download URL to the client terminal.

The web application server may provide an application list or detailed information through an app store requested by the client terminal, and in response to a search request from the client terminal, may provide, in a catalogue form, at least one of a name, a registration date, a category, and a summary description of the application.

In a case where the client terminal purchases an application of an external app store interworking with the client terminal through the integrated app store, after a payment process is done, purchase information of the application and user information may be notified to the corresponding app store.

To achieve the above objects, a method of providing an application in an integrated app store device according to the present invention may include performing registration and authentication of a client terminal, performing one of registration, search, and download of an application, providing a web front for a user, and providing an open API (Application Programming Interface) for an external app store to access.

The method may further include interworking with an app/terminal information database storing the application and terminal information and a data warehouse including an app package file storage storing an app execution package.

The open API may be a common interface based on a WAC or HTML5 standard and may support a plurality of different types of terminals and platform environments.

Providing the web front may include receiving a request for registration of the application and the terminal from the client terminal, requesting registration of the application information and the terminal information in the app/terminal information database, and transmitting unit transmitting the app package file to the app package file storage.

The method may further include downloading the application from a download server to the client terminal, in which the content managing server syncs the web application server, the interworking server, and the download server with the application information.

The authenticating may include receiving an authentication request of the client terminal and performing authentication of the client terminal in response to the authentication request and sending a request for and receiving terminal authentication information to/from the app/terminal information database.

Performing one of registration, search, and download of the application may include receiving an app store access request and an application information request from the client terminal and transmitting application display information and an application download URL to the client terminal.

Performing one of registration, search, and download of the application may include providing an application list or detailed information through an app store requested by the client terminal and in response to a search request from the client terminal, providing, in a catalogue form, at least one of a name, a registration date, a category, and a summary description of the application.

To achieve the above objects, an integrated app store system according to the present invention may include a client terminal requesting registration, search, and download of an application, an integrated app store device performing registration and authentication of the client terminal, performing one of registration, search, and download of the application, providing a web front for a user, and providing an open API (Application Programming Interface) for an external app store to access, a data warehouse storing the application information, terminal information, and an app execution package, and an external app store interworking with the integrated app store device.

The app store device, the method of providing an application in the device, and the integrated-app store system according to the present invention define functions of an app store are defined in the form of a standard-based common interface (open API) and support various terminals and platform environments, thus providing an open-type app store model that may efficiently expand services even when the type of user's terminal, type of service, or business environment is varied.

Further, the app store device, the method of providing an application in the device, and the integrated-app store system according to the present invention enable development of a common user environment where existing app stores that are being run by different service providers, respectively, may be accessed by a standardized method, prompting development of HTML5 web apps using a platform-independent technology, and making app stores distributing the apps more active.

### BRIEF DESCRIPTION OF THE DRAWINGS

FIG. 1 is a conceptual view illustrating how to provide a service in a conventional app store;

FIG. 2 is a conceptual view illustrating how to provide a service in an integrated app store system according to an embodiment of the present invention;

FIG. 3 is a block diagram schematically illustrating a configuration of an integrated app store system according to an embodiment of the present invention;

FIG. 4 is a detailed block diagram specifically illustrating a configuration of an authentication server of an integrated app store device according to an embodiment of the present invention;

FIG. 5 is a detailed block diagram specifically illustrating a configuration a web application server of an integrated app store device according to an embodiment of the present invention;

FIG. 6 is a detailed block diagram specifically illustrating a configuration of a content managing server of an integrated app store device according to an embodiment of the present invention; and

FIG. 7 is a flow schematically illustrating a method of providing an application in an integrated app store device 100 according to an embodiment of the present invention.

### DESCRIPTION OF THE EMBODIMENTS

Various modifications may be made to the present invention and the present invention may have a number of embodiments. Specific embodiments are described in detail with reference to the drawings. However, the present invention is not limited to specific embodiments, and it should be understood that the present invention includes all modifications, equivalents, or replacements that are included in the spirit and technical scope of the present invention.

The terms “first” and “second” may be used to describe various components, but the components are not limited thereto. These terms are used only to distinguish one component from another. For example, the first component may be also named the second component, and the second component may be similarly named the first component. The term “and/or” includes a combination of a plurality of related items as described herein or any one of the plurality of related items.

When a component is “connected” or “coupled” to another component, the component may be directly connected or coupled to the other component. In contrast, when a component is directly connected or coupled to another component, no component intervenes.

The terms used herein are given to describe the embodiments but not intended to limit the present invention. A singular term includes a plural term unless otherwise stated. As used herein, the terms “include” or “have” are used to indicate that there are features, numerals, steps, operations, components, parts or combinations thereof as described herein, but do not exclude the presence or possibility of addition of one or more features, numerals, steps, operations, components, parts or components thereof.

Unless defined otherwise, all the terms used herein including technical or scientific terminals have the same meanings as those generally understood by those of ordinary skill. The terms defined in the generally used dictionaries should be understood as having meanings identical to those interpreted in the context, and unless defined otherwise, the terms should not be interpreted excessively formally.

Hereinafter, preferred embodiments of the present invention will be described in greater detail with reference to the accompanying drawings. The same reference numerals refer to the same components throughout the drawings, and the description of the same components is not repeated.

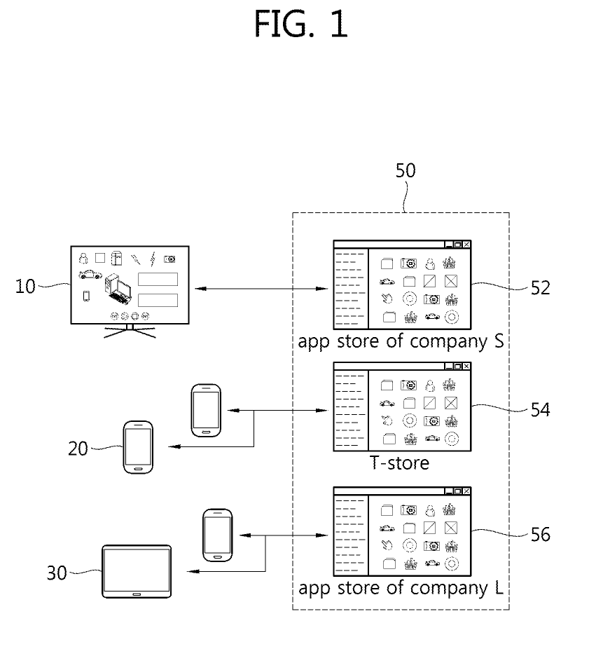

FIG. 1 is a conceptual view illustrating how to provide a service in a conventional app store. As shown in FIG. 1, the conventional app store system may include a plurality of terminals 10, 20, and 30 and an app store 50 corresponding to each of the terminals 10, 20, and 30.

Referring to FIG. 1, in the scheme in which the conventional app store system provides a service, a user independently accesses an app store of each manufacturer or communication service provider targeting an application 54 or 56 for mobile terminals or an application 52 for smart TVs corresponding to his smart TV 10 or a mobile terminal 20 or 30 to search, download, install, and use a desired application. In such scheme, the user's terminal is limited in that the terminal may gain access to each app store only via a unique app store client application that enables the terminal to access the app store, and accordingly, the same application cannot be provided to a plurality of different types of terminals.

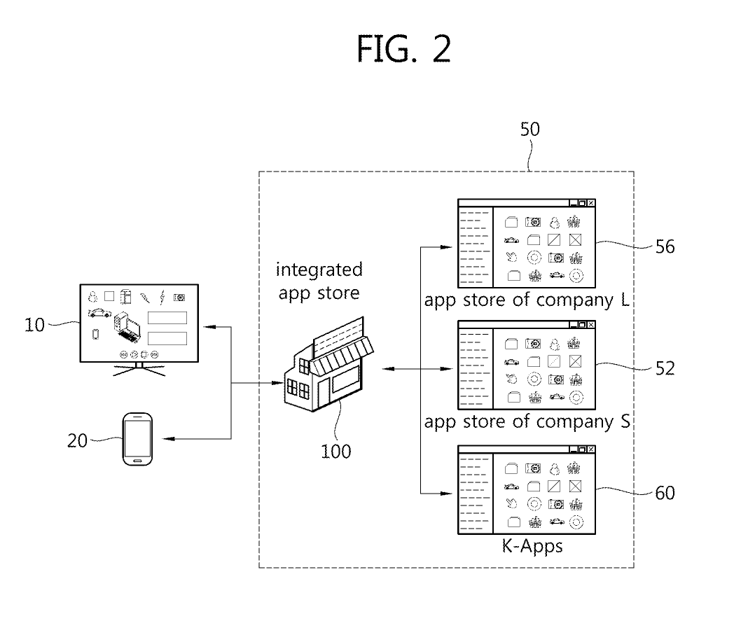

FIG. 2 is a conceptual view illustrating how to provide a service in an integrated app store system according to an embodiment of the present invention. As shown in FIG. 2, a smart TV 10 and a mobile terminal 20 are connected to an integrated app store 100, and the integrated app store 100 may be connected to a plurality of external app stores 52, 56, and 60 through an open interface (Open API).

Referring to FIG. 2, the integrated app store system according to an embodiment of the present invention interworks with other app stores 52, 56, and 60 via the open API, so that it may fetch information on an application of each mobile app store. Accordingly, a user of the smart TV 10 or the mobile terminal 20, in case an integrated app store 100 client application is installed therein, may simultaneously search applications through the integrated app store 100 client application without getting through the unique app store client application corresponding to each mobile app store 52, 56, and 60, and an HTML5-supportive web application that may be also executed on the smart TV 10 may be downloaded from the mobile app stores 52, 56, and 60 and may be installed and executed in the smart TV 10.

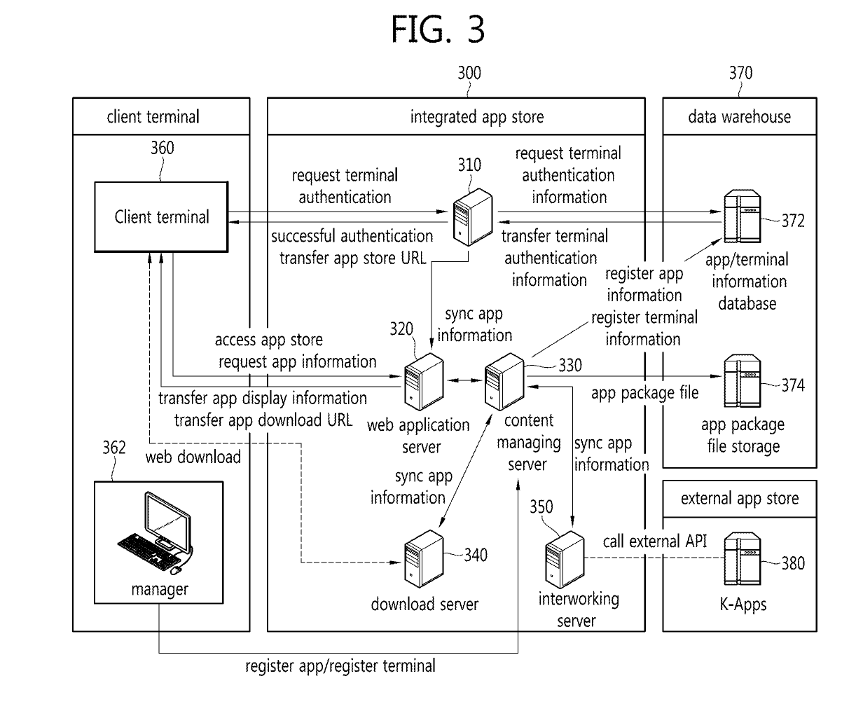

FIG. 3 is a block diagram schematically illustrating a configuration of an integrated app store system according to an embodiment of the present invention. Referring to FIG. 3, the integrated app store system according to an embodiment of the present invention may include a client terminal 360, an integrated app store 300, a data warehouse 370, and an external app store 380.

Referring to FIG. 3, the client terminal 360 means a user's terminal and may be a smart TV or a set-top box. The client terminal 360 may access the integrated app store 300 to register applications created by a user and to search, download, and install an application desired to be executed. The client terminal 360 may perform a user registration upon initial access to the integrated app store 300. User's information including payment information for purchasing applications may be registered and an account name may be assigned. Thereafter, upon access, the assigned account name may be used to perform user's authentication.

The integrated app store 300 may include an authentication server 310, a web application server 320, a content managing server 330, a download server 340, and an interworking server 350. The authentication server 310 may perform registration and authentication of the client terminal 360, i.e., smart TV or set-top box device, and registration and authentication of a user. The web application server 320 provides a web front for the user. That is, the web application server 320 receives a request of the client terminal 360 to access the integrated app store 300 and a request for application information and transmits application-related information to the client terminal 360. The content managing server 330 registers applications, and in response to a request from the client terminal 360, searches an application and prepares for download. The download server 340 performs download of an application to the client terminal 360. The content managing server 330 may sync application-related information with peripheral servers in order to induce the peripheral servers to operate with the same information when the peripheral servers perform an application-related operation. The interworking server 350 provides an open API for the external app store 380 to access the integrated app store 300 and processes it. According to an embodiment of the present invention, the open API is a WAC (Wholesale Application Community) or HTML5 standard-based common interface and may support a plurality of different types of terminals and platform environments. Accordingly, although the type of the client terminal 360 and type of service or business environment are varied, an open type app store model may be provided that may efficiently expand services.

The integrated app store 300 may interwork with the data warehouse 370. The data warehouse 370 may include an app/terminal information database 372 and an app package file storage 374. The app/terminal information database 372 stores application information and terminal information relating to the client terminal 360. The app package file storage 374 stores an application execution package.

The external app store 380 may be, as described above, a mobile app store. The external app store 380 may be an integrated mobile app store, e.g., K-Apps. In case a user purchases, via the integrated app store 300, an application of the external app store 380 interworking through the interworking server 350, after payment is processed, application purchase information and user information may be notified to the corresponding external app store 380. The external app store 380 may share the application information through application information sync with the content managing server 330 of the integrated app store 300. Accordingly, a user may inquire into an application list or details of applications through a desired app store. Further, the user may be provided with the application list and details in the form of a catalogue.

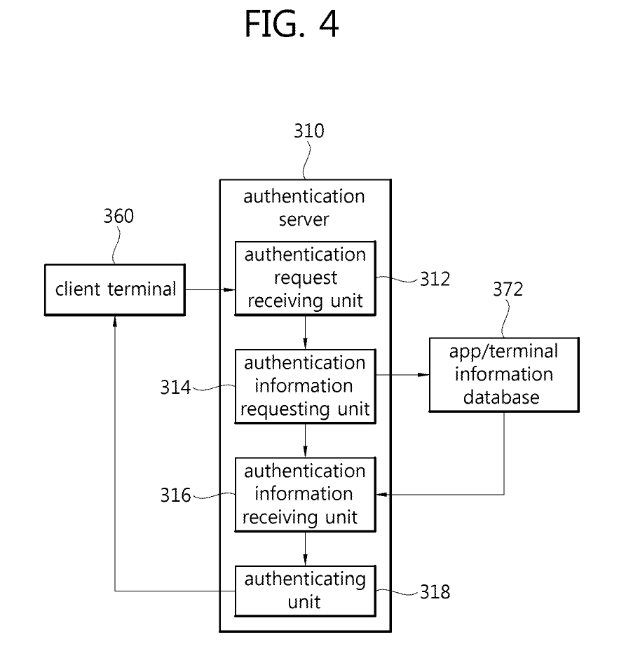

FIG. 4 is a detailed block diagram specifically illustrating a configuration of an authentication server 310 of an integrated app store device according to an embodiment of the present invention. Referring to FIG. 4, the authentication server 310 according to an embodiment of the present invention may include an authentication request receiving unit 312, an authentication information requesting unit 314, an authentication information receiving unit 316, and an authenticating unit 318.

Referring to FIG. 4, the authentication request receiving unit 312 receives an authentication request from the client terminal 360. Receiving the authentication request from the client terminal 360, the authentication information requesting unit 314 sends a request for terminal authentication information of the client terminal 360 to the app/terminal information database 372. The app/terminal information database 372 searches information relating to the client terminal 360 requesting the authentication, transmits the terminal authentication information to the authentication server 310, and the authentication information receiving unit 316 receives the terminal authentication information from the app/terminal information database 372. The authenticating unit 318 performs authentication on the client terminal 360 based on the terminal authentication information received from the authentication information receiving unit 316. In case there is a record that terminal registration to the integrated app store 300 has been conducted before, authentication may be successfully done based on the terminal authentication information, but in the case of initial access, there is no terminal authentication information, and thus, authentication may fail. In case authentication has been successfully done, the authenticating unit 318 may transmit information relating to success of the authentication to the client terminal 360. According to an embodiment of the present invention, the authentication server 310 may provide a URL (Universal Resource Locator) of an app store to the client terminal 360. Further, the authentication server 310 transmits whether terminal authentication succeeds to the web application server 320 so that access of the client terminal 360 to an app store may be managed.

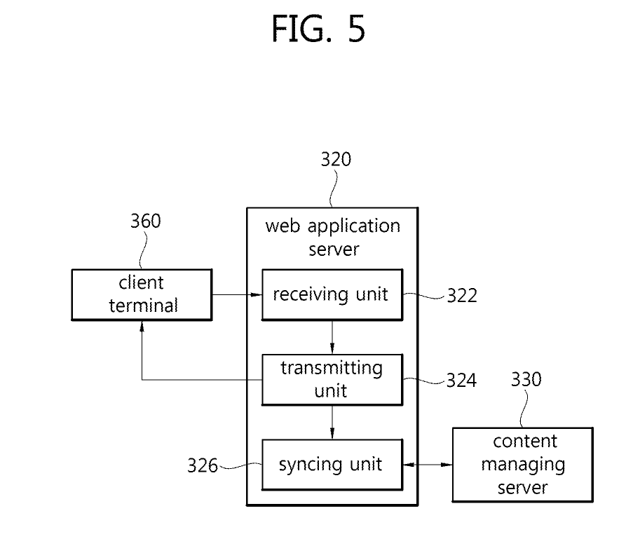

FIG. 5 is a detailed block diagram specifically illustrating a configuration a web application server 320 of an integrated app store device according to an embodiment of the present invention. Referring to FIG. 5, the web application server 320 may include a receiving unit 322, a transmitting unit 324, and a syncing unit 326.

Referring to FIG. 5, the web application server 320 may receive authentication-related information from the authentication server 310. The receiving unit 322 recognizes access of the client terminal 360 to an app store and receives an application information request. The transmitting unit 324 transmits application display information to the client terminal in response to the application information request. At this time, a download URL in which an application may be downloaded may be sent together. The transmitting unit 324 may transmit an application list and summary information in the form of a catalogue. A category is the one for directory-type inquiry and search as classified according to content treated by an application, and a user may perform sequential browsing through the catalogue or category. Further, an application may be searched using, as keywords, application information such as the name, registration date, category, and application summary description of the application, and a result of the search may be provided in the form of a catalogue. After browsing applications, a user may obtain the ID of a desired application and may request download. For the user to download the application, the transmitting unit 324 may provide the position where the application is stored in the download server 340 in the form of a URL. The client terminal 360 may access the URL and may download the application. The syncing unit 326 performs sync with the content managing server 330 and allows the application information to be synchronized.

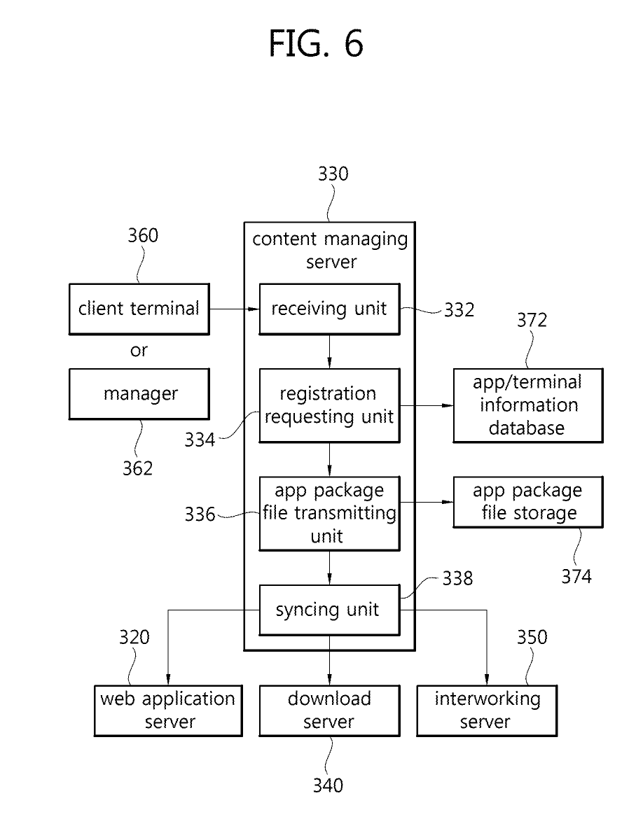

FIG. 6 is a detailed block diagram specifically illustrating a configuration of a content managing server 330 of an integrated app store device according to an embodiment of the present invention. As shown in FIG. 6, the content managing server 330 according to an embodiment of the present invention may include a receiving unit 332, a registration requesting unit 334, an app package file transmitting unit 336, and a syncing unit 338.

Referring to FIG. 6, the receiving unit 332 receives a request for registration of an application and a terminal from the client terminal 360 or the manager 362. The client terminal 360 or the manager 362 requesting registration of the application may be a producer of the application. The registration requesting unit 334 sends a request for registration of terminal information of the client terminal 360 or registration of application information to the app/terminal information database 372 in response to the request from the client terminal 360 or the manager 362. The app package file transmitting unit 336 transmits an app package file relating to the application to the app package file storage 374 and the app package file storage 374 stores the app package file. Since the app package file may be bulky or even though it is not bulky, the content managing server 330 does not have a storage space enough to store a number of app package files, the application-related app package file is transmitted to the app package file storage 374. The syncing unit 338 syncs the web application server 320, the download server 340, and the interworking server 350 with the application information. The syncing unit 338 may perform sync in real time, or as configured, may conduct sync in response to a request from other servers. Or, sync may be periodically performed.

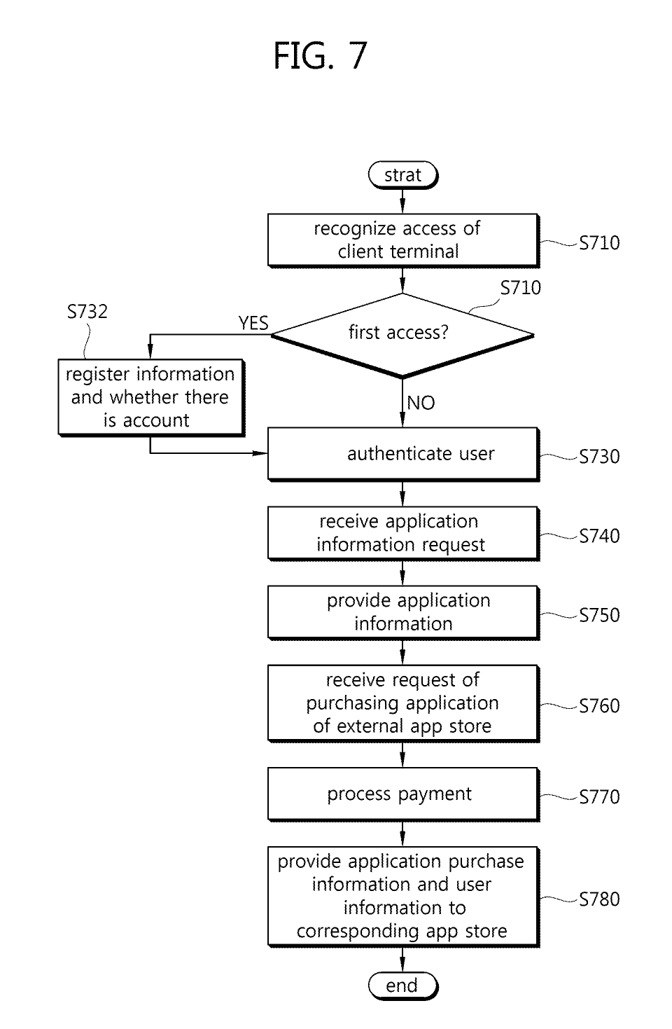

FIG. 7 is a flow schematically illustrating a method of providing an application in an integrated app store device 100 according to an embodiment of the present invention.

Referring to FIG. 7, the integrated app store device 100 recognizes access of the client terminal 360 (S710). The integrated app store device 100 determines whether access of the client terminal 360 is first access to the integrated app store device 100 (S720). This may be done through making an inquiry on terminal authentication information in the app/terminal information database 372. In the case of first access, the client terminal 360 needs to perform user registration, registers information including payment information for purchasing an application, and may be assigned an account name (S722). Upon subsequent access, user authentication is conducted through the assigned account (S730). If it is not the first access, an account previously assigned may be used to perform authentication. If user authentication is done, the integrated app store device 100 may receive a request for application information from the client terminal 360 (S740).

In response to the request for information, the integrated app store device 100 may provide application information to the client terminal 360 (S750). At this time, a list of applications registered in the integrated app store device 100 and summary information of the applications may be provided in the form of a catalogue. A user may obtain the ID of a desired application through the catalogue and requests an application using the ID. The integrated app store device 100 may receive a request for purchasing an application of an external app store from the client terminal 360 (S760). In case an application is purchased, a payment process is fulfilled based on the purchase. Such payment process is handled by a purchase-requested app store to which the user has gained access (S770). Finally, upon completion of the purchase, only the user information and information on the result of the purchase process may be provided to the app store that possesses the corresponding application (S780).

The following table shows open APIs that the integrated app store should provide for interworking with an external app store. Among service functions of an app store, a function that should be exposed to the outside is defined as an open API, and this may be provided to be called from the outside.

TABLE 1

| | | open API | |
|---|---|---|---|
| Functions | API | or no | Description |
| Catalogue | App catalogue | ◯ | Provides app list including |
| function | parameter: catalog = all | | app summary information in |
| | | | catalogue |
| | app catalogue update | ◯ | requests update of app |
| | parameter: | | catalogue. Changed app |
| | catalog = update | | information only is updated |
| | | | and provided. |
| | App category list | ◯ | provides an app category |
| | parameter: category = 0 | | list. The category list |
| | | | includes weather, games, |
| | | | education, business, |
| | | | pictures and videos, social |
| | | | networking, sports, travel, |
| | | | food, music, science, |
| | | | medicine, entertainment, |
| | | | etc. |
| | Per-category app | ◯ | provides an app catalogue |
| | catalogue | | belonging to app category. |
| | parameter: | | |
| | category = category name | | |
| | Recommended app list | ◯ | provides a catalogue for |
| | parameter: | | recommended apps. |
| | category = recommend | | policy for recommendation |
| | | | of apps may vary per app |
| | | | store. |
| App | App information | ◯ | provides details of an app. |
| searching | parameter: key = I.D. | | |
| function | Search app information | ◯ | transmits an app search |
| | parameter: | | keyword, searches a |
| | appname = app name, | | corresponding app, and |
| | kinds = app type, | | provides a result as detailed |
| | category = category, | | information. |
| | uploaddate = registration | | |
| | date, | | |
| | desc = app description | | |
| | (keyword) | | |
| | App history information | X | provides history information |
| | parameter: | | for purchase, download, or |
| | category = category name | | install of an app. The |
| | purchase, download, | | purchased app may be |
| | install, delete | | downloaded and installed |
| | | | again. |
| Downloading | App download URL | ◯ | provides the URL of a |
| function | | | download server from which |
| | | | an app is to be downloaded. |
| Purchasing | transmit app purchase | ◯ | after purchase of an app, |
| function | information | | provides user information |
| | | | for completion of the |
| | | | purchase and information |
| | | | on the purchased app. |
| | Request app purchase | X | requests payment process |
| | (provide payment | | using user's payment |
| | information) | | information to purchase an |
| | | | app. |
| Authenticating | Request terminal | X | provides information on a |
| function | authentication | | registered terminal. |

Although exemplary embodiments of the present invention have been described with reference to the accompanying drawings, it should be noted that the scope of the invention is not limited thereto and various modifications and variations may be made thereto without departing from the scope and spirit of the invention defined by the appended claims.

What is claimed is:

1. An integrated app store device comprising:
an authentication server performing registration and authentication on a client terminal;
a content managing server performing one of registration, search, and download of an application;
a web application server providing a web front for a user; and
an interworking server providing an open API (Application Programming Interface) for an external app store to access.

2. The integrated app store device of claim 1, wherein the client terminal is a smart TV or a set-top box, and wherein the external app store is a mobile app store.

3. The integrated app store device of claim 1, wherein the open API is a common interface based on a WAC (Wholesale Application Community) or HTML5 standard and supports a plurality of different types of terminals and platform environments.

4. The integrated app store device of claim 1, wherein the integrated app store device interworks with:
an app/terminal information database storing the application and terminal information; and
a data warehouse including an app package file storage storing an app execution package.

5. The integrated app store device of claim 4, wherein the content managing server comprises:
a receiving unit receiving a request for registration of the application and the terminal from the client terminal;
a registration requesting unit requesting registration of the application information and the terminal information in the app/terminal information database; and
an app package file transmitting unit transmitting the app package file to the app package file storage.

6. The integrated app store device of claim 1, further comprising a download server downloading the application to the client terminal, wherein the content managing server syncs the web application server, the interworking server, and the download server with the application information.

7. The integrated app store device of claim 1, wherein the authentication server comprises:
a client terminal communication unit receiving an authentication request of the client terminal and performing authentication of the client terminal in response to the authentication request; and
an app/terminal information database communication unit sending a request for and receiving terminal authentication information to/from the app/terminal information database.

8. The integrated app store device of claim 7, wherein the authentication server transfers an app store URL (Universal Resource Locator) to the client terminal.

9. The integrated app store device of claim 1, wherein the web application server comprises:
a receiving unit receiving an app store access request and an application information request from the client terminal; and
a transmitting unit transmitting application display information and an application download URL to the client terminal.

10. The integrated app store device of claim 1, wherein the web application server provides an application list or detailed information through an app store requested by the client terminal, and in response to a search request from the client terminal, provides, in a catalogue form, at least one of a name, a registration date, a category, and a summary description of the application.

11. The integrated app store device of claim 1, wherein in a case where the client terminal purchases an application of an external app store interworking with the client terminal through the integrated app store, after a payment process is done, purchase information of the application and user information are notified to the corresponding app store.

12. A method of providing an application in an integrated app store device, the method comprising:
performing registration and authentication of a client terminal;
performing one of registration, search, and download of an application;
providing a web front for a user; and
providing an open API (Application Programming Interface) for an external app store to access.

13. The method of claim 12, further comprising interworking with an app/terminal information database storing the application and terminal information and a data warehouse including an app package file storage storing an app execution package.

14. The method of claim 12, wherein the open API is a common interface based on a WAC (Wholesale Application Community) or HTML5 standard and supports a plurality of different types of terminals and platform environments.

15. The method of claim 13, wherein providing the web front comprises:
receiving a request for registration of the application and the terminal from the client terminal;
requesting registration of the application information and the terminal information in the app/terminal information database; and
transmitting unit transmitting the app package file to the app package file storage.

16. The method of claim 12, further comprising downloading the application from a download server to the client terminal, wherein the content managing server syncs the web application server, the interworking server, and the download server with the application information.

17. The method of claim 13, wherein said authenticating comprises:
receiving an authentication request of the client terminal and performing authentication of the client terminal in response to the authentication request; and
sending a request for and receiving terminal authentication information to/from the app/terminal information database.

18. The method of claim 12, wherein performing one of registration, search, and download of the application comprises:
receiving an app store access request and an application information request from the client terminal; and
transmitting application display information and an application download URL to the client terminal.

19. The method of claim 12, wherein performing one of registration, search, and download of the application comprises:
providing an application list or detailed information through an app store requested by the client terminal; and
in response to a search request from the client terminal, providing, in a catalogue form, at least one of a name, a registration date, a category, and a summary description of the application.

20. An integrated app store system comprising:
a client terminal requesting registration, search, and download of an application;
an integrated app store device performing registration and authentication of the client terminal, performing one of registration, search, and download of the application, providing a web front for a user, and providing an open API (Application Programming Interface) for an external app store to access;
a data warehouse storing the application information, terminal information, and an app execution package; and
an external app store interworking with the integrated app store device.
